(19) United States
(12) Patent Application Publication
(10) Pub. No.: US 2012/0233616 A1
(43) Pub. Date: Sep. 13, 2012

(54) STREAM DATA PROCESSING METHOD AND STREAM PROCESSOR

(76) Inventors: Simon Moy, Mountain View, CA (US); Shihao Wang, Shenzhen (CN); Wing Yee Lo, Shenzhen (CN); Kaimin Feng, Shenzhen (CN); Hua Bai, Shenzhen (CN)

(21) Appl. No.: 13/395,502

(22) PCT Filed: Dec. 28, 2009
(86) PCT No.: PCT/CN2009/076108

§ 371 Date: Mar. 12, 2012

(30) Foreign Application Priority Data
Nov. 27, 2009 (CN) 200910188409

(51) Int. Cl. G06F 9/46

(52) U.S. Cl. 718/100

(57) ABSTRACT

A stream data processing method is provided, which includes the steps as follows: obtaining from data a program pointer indicating a task to which the pointer belongs, and configures a thread processing engine according to the program pointer; processing simultaneously the data of the different durations of the task or the data of different tasks by a plurality of thread engines; decides whether there is data still not processed, and if yes, returns to the first step; and if no, exits this data processing. A processor for processing a stream data is also provided.

### TECHNICAL FIELD OF THE INVENTION

The present invention relates to the field of data processing, and in particular to a stream data processing method and a stream processor.

### BACKGROUND OF THE INVENTION

The development of electronic technology has a higher and higher demand on processor; generally, an integrated circuit engineer provides more or better performances for users by increasing clock speed, adding hardware resource and special application function; however, this practice is not suitable in some application occasions, particularly in mobile applications. Generally, the increase of the raw speed of processor clock can not break the bottleneck of the processor caused by the limit of peripheral speed and access memory. For the processor, the addition of hardware requires higher use efficiency of lots of processors in use; due to lack of instruction level parallelism (ILP), the addition of hardware mentioned above is generally impossible. However, the adoption of special function module would limit the application scope of the processor and delay the product time-to-market; especially for the stream media widely applied at present, due to the wide range of application, particularly in terminal devices, most stream medias are applied to the portal mobile terminals charged by battery, the problems above are more obvious; although improving the hardware performance alone, for example, increasing the clock frequency and increasing the kernel number in processor, to some extent can solve the problems above, the cost and power consumption might be increased, thus the cost is too high and the cost performance is not high.

### SUMMARY OF THE INVENTION

In view of the defects in the prior art that the cost and power consumption are increased, the cost is too high and the cost performance is not high, the technical problem to be solved by the present invention is to provide a stream data processing method and a stream processor with high cost performance.

The technical scheme applied by the present invention to solve the technical problem is to: construct a stream data processing method, comprising the steps as follows:

A) obtaining from data a program pointer indicating a task to which the pointer belongs, and configuring a thread processing engine according to the program pointer;

B) processing simultaneously the data of the different durations of the task or the data of different tasks by a plurality of thread engines;

C) deciding whether there is data still not processed, and if yes, returning to the Step A); and if not, exiting this data processing.

In the stream data processing method of the present invention, the Step A) further comprises a step of:

A1) respectively allocating the data of the different durations of the same task or the data of a plurality of tasks to different idle local storage units which are connected with the thread processing engines through virtual direct memory access (DMA) channels;

In the stream data processing method of the present invention, the Step A) further comprises the steps of:

A2) allocating the same task to the plurality of thread processing engines;

A3) initializing each thread processing engine, and connecting the thread processing engine with a local storage unit through the virtual DMA channel by setting a storage pointer;

A4) processing simultaneously, by the plurality of thread processing engines, the data in the local storage units connected with the thread processing engines.

In the stream data processing method of the present invention, the Step A) further comprises the steps of:

A2′) allocating a plurality of tasks to the plurality of thread processing engines respectively;

A3′) initializing each thread processing engine, and connecting the thread processing engine with a local storage unit through the virtual DMA channel by setting a storage pointer;

A4′) processing simultaneously, by the plurality of thread processing engines, the data in the local storage units connected with the thread processing engines.

In the stream data processing method of the present invention, the Step C) further comprises the steps of:

C1) releasing the local storage unit connected with the multi-thread processing engine through the virtual DMA channel;

C2) deciding whether there is data not processed in the local storage units not connected with the plurality of thread processing engines, if yes, returning to Step A), if not, executing Step C3).

C3) releasing all resources and ending this data processing.

In the stream data processing method of the present invention, the number of the thread processing engines is four, and the number of the local storage units is four or eight.

The stream data processing method of the present invention further comprises a step of: when receiving an interrupt request sent by the task or hardware, interrupting the processing of the thread processing engine allocated to the task and executing an interrupt processing program.

The stream data processing method of the present invention further comprises a step of: when any of the running thread processing engines needs to wait a long time, releasing the thread processing engine and configuring it to another same or different running task.

The present invention also refers to a processor for processing stream data, comprising:

a plurality of parallel thread processing engines for processing tasks or threads allocated to the thread processing engines;

a management unit for obtaining, judging and controlling the statuses of the plurality of thread processing engines, and allocating the threads or tasks in a waiting queue to the plurality of thread processing engines;

a local storage area for storing the data processed by the thread processing engine and cooperating the thread processing engine to finish the data processing.

The processor of the present invention further comprises an internal storage system for data and thread buffering and instruction buffering, and a register for storing various statuses of the parallel processor.

In the processor of the present invention, the thread processing engine comprises an arithmetic logic unit (ALU) and a multiply-add unit (MAC) corresponding to the ALU.

In the processor of the present invention, the local storage area comprises a plurality of local storage units; and the local storage unit is configured to correspond to the thread processing engine when the thread processing engine works.

In the processor of the present invention, the thread processing engines are four and the local storage units are eight; when the thread processing engines work, any four of the local storage units are configured to correspond to the thread processing engines one to one respectively.

In the processor of the present invention, the management unit comprises:

a software configuration module for setting a task for the thread processing engine according to an initial program pointer;

a task initialization module for setting the local storage area pointer and global storage area pointer of the task;

a thread configuration module for setting the priority and the running mode of a task;

an interrupt processing module for processing the external or internal interrupt received by the stream processor;

a pause control module for controlling the pause or the restart when the thread processing engine processes a task.

In the processor of the present invention, the management unit further comprises a thread control register; the thread control register further comprises an initial program pointer register for indicating the start physical address of a task program, a local storage area start base point register for indicating the start address of the local storage area, a global storage area start base point register for indicating the start address of the thread global storage area and a thread configuration register for setting the priority and the running mode of the thread.

In the processor of the present invention, the management unit changes the task run by the thread processing engine by changing the configuration of the thread processing engine; the configuration comprises changing the value of the initial program pointer register or changing the local storage unit pointer pointing to the local storage unit.

In the processor of the present invention, the interrupt processing module comprises an interrupt processing unit; the thread interrupt unit controls the interrupt of threads in the kernel or other kernels when the control bit of the interrupt register is set.

The implementation of the stream data processing method and the stream processor of the present invention has the following advantages: since hardware is improved to some extent, a plurality of parallel ALUs and the corresponding storage system in the kernel are used, and the threads to be processed by the processor are managed by a software and thread management unit, thus the plurality of ALUs reaches dynamic load balance when task is saturated, and partial ALUs are shut down when task is not saturated to save power consumption; therefore, high performance can be achieved with a small cost and the cost performance is high.

### BRIEF DESCRIPTION OF THE DRAWINGS

FIG. 1 shows a method flowchart in an embodiment of the stream data processing method and the stream processor in the present invention;

FIG. 2 shows a structure diagram of the processor in the embodiment;

FIG. 3 shows a structure diagram of a data thread in the embodiment;

FIG. 4 shows a structure diagram of a task thread in the embodiment;

FIG. 5 shows a structure diagram of an MVP thread in the embodiment;

FIG. 6 shows a structure diagram of an MVP thread in the embodiment;

FIG. 7 shows a structure diagram of MVP thread operation and operation mode in the embodiment;

FIG. 8 shows a structure diagram of MVP thread local storage in the embodiment;

FIG. 9 shows a structure diagram of instruction output in the embodiment;

FIG. 10 shows a diagram of MVP thread buffering configuration in the embodiment; and

FIG. 11 shows a diagram of configuration between the local storage units and the thread processing engines in the embodiment.

### DETAILED DESCRIPTION OF THE INVENTION

The embodiment of the present invention is further illustrated below in conjunction with accompanying drawings.

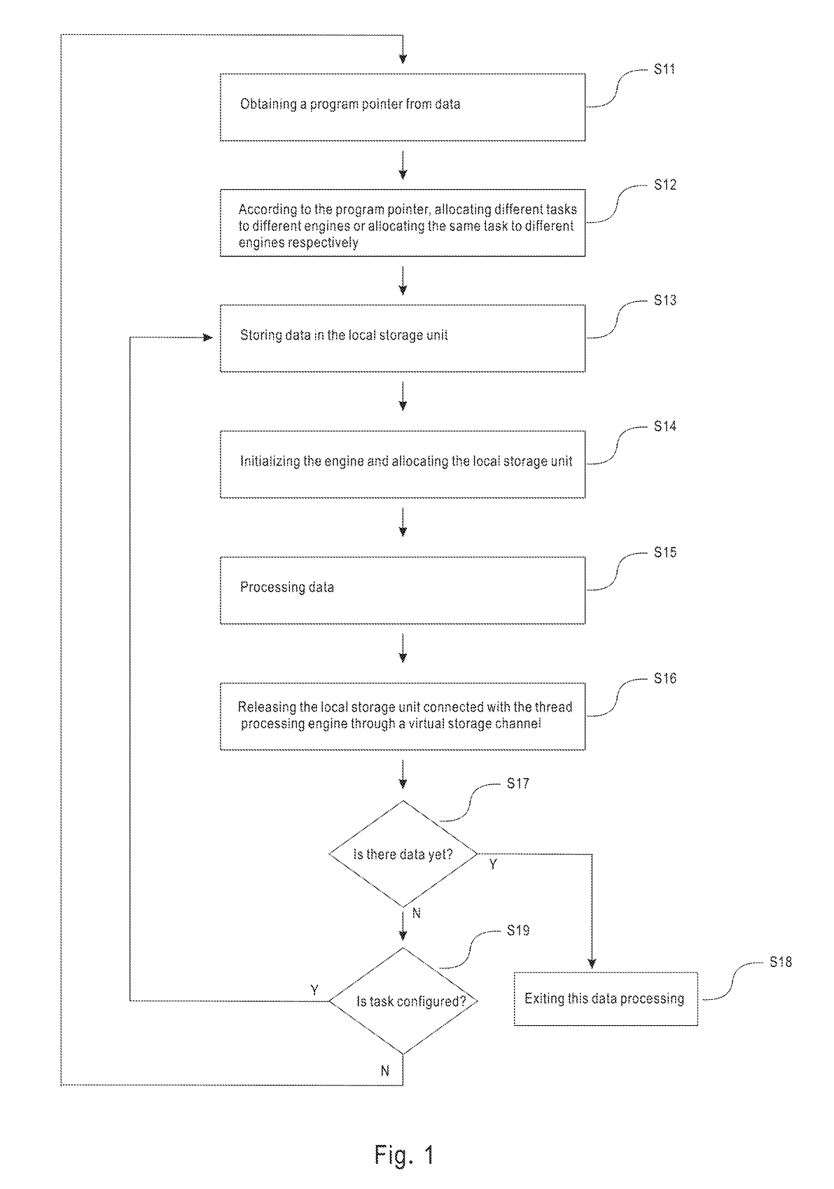

As shown in FIG. 1, in an embodiment of the stream data processing method and the stream processor in the present invention, the stream data processing method comprises the steps as follows:

S11: obtaining a program pointer from data. Generally, in a processor, there might be different tasks needing to be processed at the same time, however, in the processing of stream data, this condition is common too, for example, two routes of different stream data are input simultaneously and the two routes of data need to be processed simultaneously; of course, one route of data can be processed first, and then the other route of data is processed, however, this method would cause time delay. However, in a time sensitive task, the stream data need to be processed simultaneously, which is a basis of the embodiment. Of course, in another condition, there might be one route of data input, thus only one processing program is needed. In this condition, this route of data also can be processed by only one thread processing engine; however, the time consumed obviously is longer than the time consumed when multiple thread processing engines are used to process this route of data simultaneously. In the embodiment, the input data carries program pointers when needing to be processed, and the program pointers indicate the existence of the programs needed by processing the data.

S12: according to the program pointer, allocating different tasks to different engines or allocating the same task to different engines respectively; in S12, there are two conditions; one condition is there is only one task; in the embodiment, there are four thread processing engines; of course, it is possible to use only one thread processing engine to process this task, however, in this condition, processing time is delayed; moreover, three thread processing engines are remained not working, which is a waste; therefore, in this step, the task is configured to four thread processing engines simultaneously but the thread processing engines process different data, so that the four thread processing engines concurrently process the data of the different durations of the task, to complete the task in a quicker time. The other condition is the data belongs to a plurality of tasks respectively; the four thread processing engines above need to concurrently process the plurality of tasks but process different data. When the task number is greater than the engine number, four tasks above are configured to the four thread processing engines above, each engine processing a task; the excess tasks wait in a queue and are configured until the engines finish processing the current task; when the task number is just four, each engine is configured with a task; when the task number is less than four but greater than one, the thread processing engines are allocated averagely or each task is allocated with a thread processing engine and the rest engine is assigned to execute the task with higher priority.

S13: storing data in the local storage unit. In S13, the stream data of the current tasks is stored to the local storage units respectively according to different tasks or different input durations. Of course, the stream data is input uninterruptedly; the stream data input uninterruptedly is sent to the local storage units after being subjected to input cache, wherein the amount of data stored in each local storage unit can be the same or different according to the characteristics of the stream data. In the embodiment, the size of each local storage unit is the same; therefore, the amount of data input to the local storage unit is the same too. Moreover, when the data from different stream data is stored to different local storage units, the local storage units are marked, so that the source of the data stored in the local storage units can be identified.

S14: initializing the engine and allocating the local storage unit. In S14, the thread processing engine is initialized to be ready to process data; during the initialization of the engine, one important point is to configure the local storage unit stored with the task data to the corresponding thread processing engine, that is, connect a local storage unit to a thread processor through a virtual storage channel. The virtual storage channel in the embodiment is a virtual DMA connection, and no corresponding hardware exists. The corresponding thread processing engines above are the thread processing engines connected with the local storage units and obtaining task execution codes. It is worth mentioning that the embodiment comprises eight local storage units, wherein four local storage units are configured to the thread processing units and the rest four local storage units form a queue which waits to be configured to the thread processing engines; the four waiting local storage units are stored with the data from the input cache; of course, if there is no data in the input cache, the local storage unit can be empty, with no data stored. In addition, the task of initializing engine further comprises endowing the local storage area pointer and the global storage area pointer to the engine, and setting the priority and the running mode of the engine.

S15: processing data. In S15, the thread processing engines process the data in the local storage units configured to the engines; of course, the processing is executed under the control of the execution code of the task according to the requirement. It is worth mentioning that in S15 the data processed by each thread processing engine might be the input data of the different durations of the same task, also can be the input data of the same duration of different tasks, also can be the input data of the different durations of different tasks.

S16: releasing the local storage unit connected with the thread processing engine through a virtual storage channel. After a thread processing engine finishes processing the data in the local storage unit configured (connected through the virtual DMA channel) to the engine, the thread processing engine releases the configured local storage unit first and then transmits the data to a next thread processing engine through the virtual DMA channel; after the local storage unit is released, the local storage unit joins the queue waiting to be configured to the thread processing engine. Like other local storage units not allocated to the thread processing engines, the data input to the cache (if any) is input to the local storage unit.

S17: are all tasks completed? In S17, it is judged whether all tasks are completed, if yes, S18 is executed; if not, S19 is executed. An obvious judgment criteria is to judge whether there is data in the input cache and the local storage unit not configured to the thread processor, if not, it can be judged that the task is processed.

S18: exiting this data processing. In S18, one or more tasks are completed, and the corresponding one or more local storage units are released; here, one or more thread processing engines corresponding to the task and other resources are released, this data processing of the task is exited.

S19: is task configured? In S19, if there is a task not completed, and the task has been configured to the thread processor, it is returned to S13; a new local storage unit is configured to the thread processor configured with the task, then the data of the local storage unit is processed; if there is a task not processed, and the task has not configured to the thread processing engine, it is retuned to S11; a thread processing engine is configured for the task, if there is no idle thread processing engine, an idle thread processing engine is waited to appear. In other embodiments, if the task is configured, but there is still idle thread processing engine, it also can be returned to S11; a thread processing engine is configured for the task again, so as to speed up the processing rate. The judgment whether the task is configured is still to use the program pointer in the data, if the program pointer in the data has been read out but the thread processing engine configured to the pointer has not exited, it can be considered that the task has been configured; otherwise, it can be judged that the task is not configured.

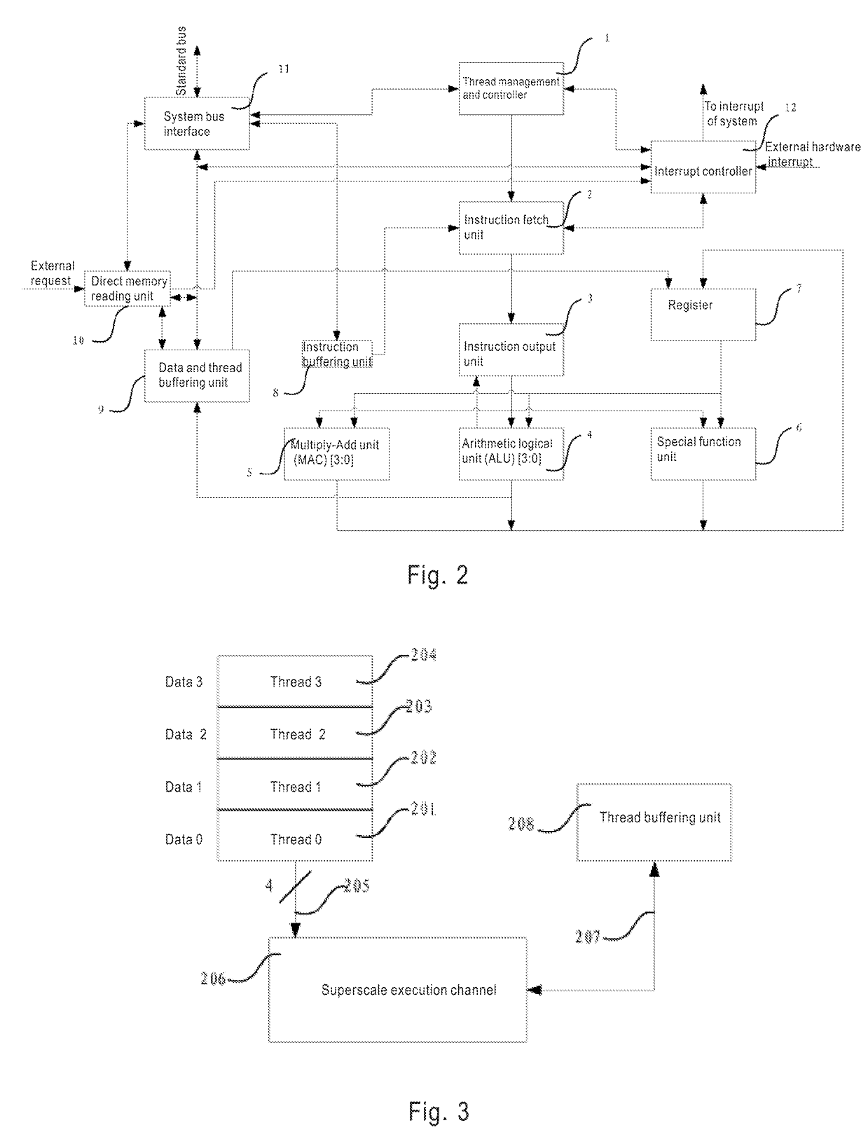

The present invention also refers to a processor for processing stream data, as shown in FIG. 2, in the embodiment, the processor is a parallel MVP processor, wherein the processor comprises a thread management and control unit 1, an instruction fetch unit 2, an instruction output unit 3, an ALU [3:0] 4, an MAC [3:0] 5, a special function unit 6, a register 7, an instruction buffering unit 8, a data and thread buffering unit 9, a direct memory reading unit 10, a system bus interface 11 and an interrupt controller 12, in which, the thread management and control unit 1 is used for managing and controlling the currently prepared threads, the running threads and so on, and is connected with the system bus interface 11, the instruction fetch unit and the interrupt controller 12 respectively; the instruction fetch unit 2 acquires an instruction through the instruction buffering unit 8 and the system bus interface 11 under the control of the thread management and control unit 1, and outputs the fetched instruction to the instruction output unit 3 under the control of the thread management and control unit 1, meanwhile, the instruction fetch unit 2 is connected with the interrupt controller 12, accepts the control from the interrupt controller 12 when the interrupt controller 12 has an output, and stops fetching instruction; the output of the instruction output unit 3 is connected with the ALU [3:0] 4, the MAC [3:0] 5 and the special function unit 6 via parallel buses, and sends the operation code and operand in the fetched instruction to the four ALUs, the four MACs and the special function unit 6 above respectively according to requirement; the ALU [3:0] 4, the MAC [3:0] 5 and the special function unit 6 also are connected with the register 7 respectively via buses, so as to write the changes of the statuses therein to the register 7 in time; the register 7 is also connected with the ALU [3:0] 4, the MAC [3:0] 5 and the special function unit 6 above respectively (different from the connection above), so as to write the changes of statuses (not caused by the three units above, for example, the status is directly written by software) therein to the three units above; the data and thread buffering unit 9 is connected to the system bus interface 11, acquires data and instruction through the system bus interface 11 and stores the acquired data and instruction for other units (particularly the instruction fetch unit 2) to read; the data and thread buffering unit 9 also is connected with the direct memory reading unit 10, the ALU [3:0] 4 and the register 7 respectively. In the embodiment, a thread processing engine comprises an ALU and an MAC; therefore, in the embodiment, four parallel thread processing engines running on the hardware are included.

In the embodiment, the thread management and control unit 1 further comprises: a software configuration module for setting a task for the thread processing engine according to an initial program pointer; a task initialization module for setting the local storage area pointer and global storage area pointer of the task; a thread configuration module for setting the priority and the running mode of a task; an interrupt processing module for processing the external or internal interrupt received by the stream processor; a pause control module for controlling the pause or the restart when the thread processing engine processes a task; and an ending module for exiting this data processing, wherein the ending module runs command EXIT to make the thread processing engine exit from the data processing.

In the embodiment, the implementation channel of the MVP includes four ALUs, four MACs and a 128×32-bit register; in addition, the implementation channel further includes a 64 KB instruction buffering unit, a 32 KB data buffering unit, a 64 KB system random access memory (SRAM) acting as a thread buffer, and a thread management unit.

The MVP supports two parallel computing modes, namely, data parallel computing mode and task parallel computing mode. When processing the data parallel computing mode, the MVP kernel in one work group at most can process four work items, wherein the four work items are mapped to four parallel threads of the MVP kernel. When processing the task parallel computing mode, the MVP kernel at most can process eight work groups, each work group including one work item, wherein the eight work items also are mapped to eight parallel threads of the MVP kernel; in view of hardware, the task parallel mode has no difference from the data parallel mode. More important, in order to achieve maximum cost performance, the MVP kernel further comprises a dedicated mode, namely, MVP thread mode; in the MVP thread mode, at most eight threads can be configured as the MVP thread mode and the eight threads are presented as a dedicated chip channel hierarchy. In the MVP mode, the eight threads all can be uninterruptedly applied to different kernels which are used for stream processing or stream data processing. Typically, in various stream processing applications, the MVP mode has higher cost performance.

Multi-thread and application thereof are one of the important differences between the MVP and other processors, and can definitely realize a final better solution. In the MVP, the purpose of multi-thread is as follows: providing task parallel and task parallel processing modes, and providing a dedicated function parallel mode which is designed for stream channel; adopting load balance to realize maximum hardware resource utilization in the MVP, and reducing the latency hiding capability depending on memory and peripheral speed. In order to discover the advancements of the use of multi-thread and the performance of multi-thread, the MVP removes or reduces excessive special hardware, particularly the hardware set for realizing a special application. Compared with the improvement of hardware performance alone, for example, the improvement of CPU clock rate, the MVP has better generality and flexibility in different applications.

In the embodiment, the MVP supports three different parallel thread modes, including data parallel thread mode, task thread parallel mode and MVP parallel thread mode, in which, the data parallel thread mode is used for processing different stream data passing through the same kernel, for example, the same program in the MVP. (Referring to FIG. 3), data arrives at different time, and the start time of processing is different too. When the threads are running, even if the program which processes them is the same one, the threads are still in different operation flows. In view of MVP instruction channel, there is no difference in the programs with different operations, for example, different tasks. Each data set put to the same thread is a self-contained minimum set, for example, no communication is needed with other data sets, which means that the data thread would not be interrupted for communication with other threads. Each data thread is presented as a work item. FIG. 3 comprises four threads corresponding to data 0 to data 3, namely, thread 0 to thread 4 (201, 202, 203, 204), a superscale execution channel 206, a thread buffering unit 208 (i.e. local memory), a bus 205 connecting the threads (data) with the superscale execution channel 206, a bus 207 connecting the superscale execution channel 206 with the thread buffering unit 208 (i.e. local memory). As mentioned above, in the data parallel mode, the four threads above are the same, and the data thereof is the data of the thread at different time. The essence is that the data input at different time of the same program is processed at the same time. In this mode, the local memory participates in the process above as a whole.

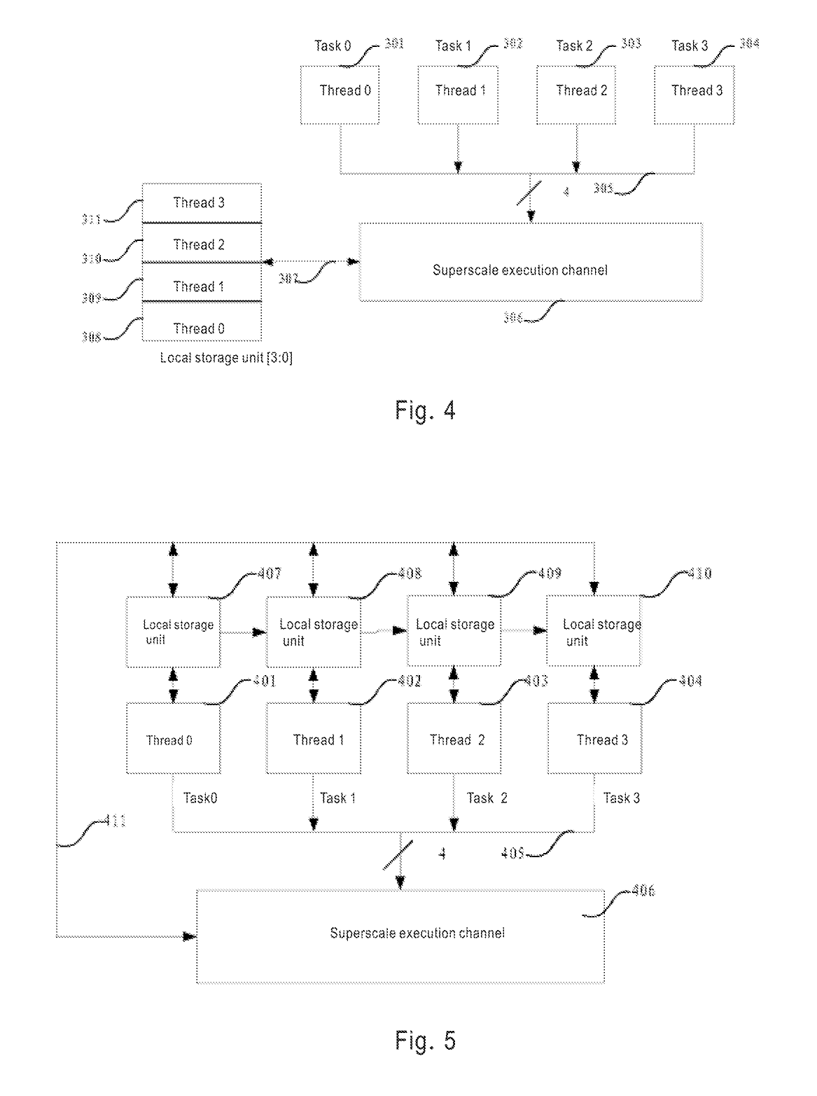

Task threads concurrently run on different kernels. Referring to FIG. 4, in view of operation system, the task threads are presented as different programs or different functions. In order to achieve higher flexibility, the characteristics of task threads totally upgrade to software classification. Each task runs on a different program; the task thread would not be interrupted for communication with other threads; each task thread is presented as a work group with a work item. FIG. 4 comprises thread 0 301, thread 1 302, thread 2 303 and thread 3 304 corresponding to task 0 to task 3, wherein the threads are connected with a superscale execution channel 306 respectively via four parallel I/O wires 305, meanwhile, the superscale execution channel 306 is also connected with the local storage area via a storage bus 307; at this moment, the local storage area is divided into four parts (i.e. four local storage units), which are the areas used for storing the data corresponding to the four threads (301, 302, 303, 304) above respectively, wherein the areas are the area 308 corresponding to thread 0, the area 309 corresponding to the thread 1, the area 310 corresponding to the thread 2 and the area 311 corresponding to the thread 3 respectively. Each of the threads (301, 302, 303, 304) reads data in the corresponding areas (308, 309, 310, 311) respectively.

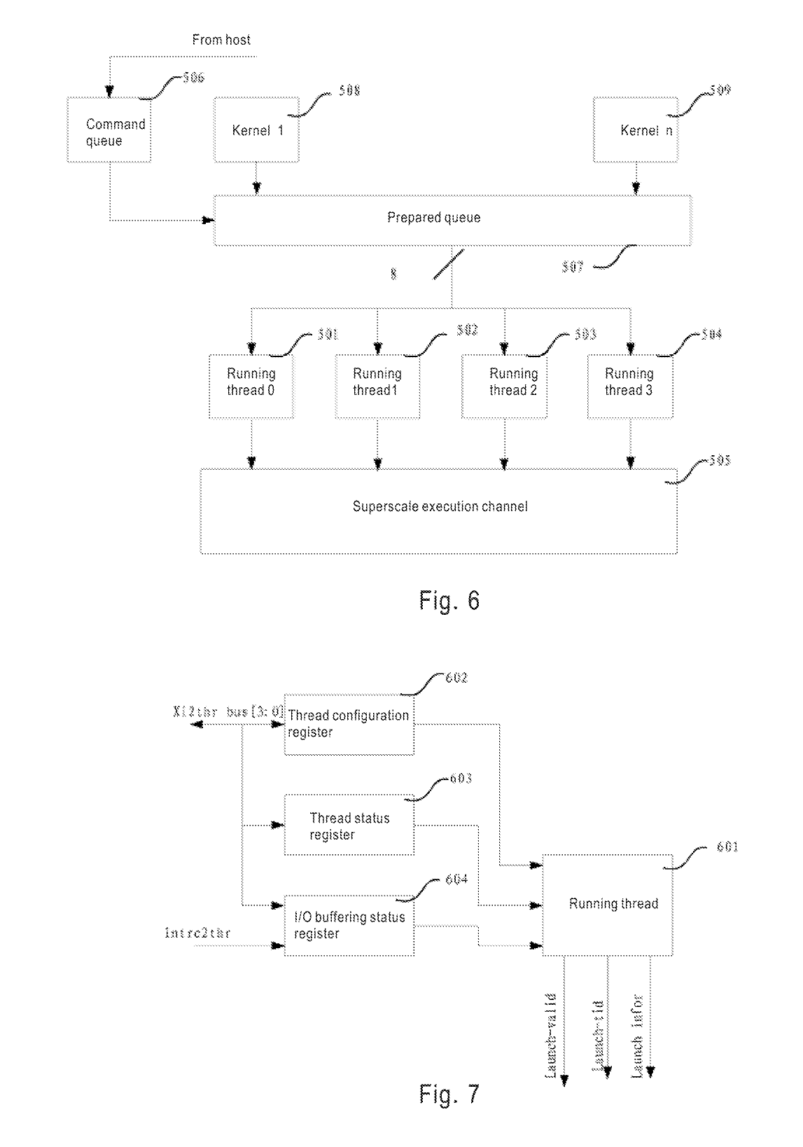

In view of application specific integrated circuit, MVP threads are presented as different function channel layers, which are the design points and key characteristics. Each function layer of the MVP thread is similar to different running kernels, just as the task thread. The greatest feature of the MVP thread is that the MVP thread can activate or shut down itself automatically according to the input data status and the output buffering capability. The capability that the MVP thread automatically activates or shuts down itself enables the thread to remove the completed threads from the currently executing channel and release hardware resource for other activated threads; thus, the load balance capability we expect is provided; in addition, the MVP thread can activate more threads than the running threads and supports at most eight activated threads; the eight threads are dynamically managed, wherein at most four threads can run while the other four activated threads wait idle running time periods. Referring to FIG. 5 and FIG. 6, FIG. 5 shows the relationship between the thread and the local storage unit in the MVP mode, wherein thread 0 401, thread 1 402, thread 2 403 and thread 3 404 are connected with a superscale execution channel 406 respectively via parallel I/O connection wires 405; meanwhile, the threads (tasks) also are connected separately with the areas (407, 408, 409, 410) allocated to the threads in the local storage unit; among the areas, through virtual DMA engine connection, the virtual DMA enables quick transfer of the data between the divided areas when needed; in addition, the divided areas are connected with a bus 411 respectively, and the bus 411 is connected with the superscale execution channel 406 too. FIG. 6 describes the thread condition in the MVP mode in another view. FIG. 6 comprises four running threads, namely, running thread 0 501, running thread 1 502, running thread 2 503 and running thread 3 504, wherein the four threads run on the four ALUs above respectively, and are connected with a superscale execution channel 505 via parallel I/O wires respectively; meanwhile, the four running threads are connected with a prepared thread queue 507 respectively (actually, the four threads are extracted from the thread queue 507); from the description above, it can be known that there are prepared but not running threads in the queue above, and the prepared but not running threads at most can be eight; of course, according to actual application, the threads might be less than eight; wherein the prepared threads can be the same kernel (application or task, kernel 1 508 to kernel n 509 in FIG. 6) or not; in extreme conditions, the threads might belong to eight different kernels (applications or tasks) respectively; of course, it might be other number in actual application; for example, the threads might belong to four applications, while each application might have two threads prepared (in the condition of the same thread priority). The threads in the queue 507 are from an external host through the command queue 509 in FIG. 6.

In addition, if a follow-up thread of a special time-consuming thread in the circular buffering queue has requirement, the same thread (kernel) can be started in multiple running time periods. In this condition, the same kernel can start more threads one time so as to speed up the follow-up data processing in the circular buffer.

The combination of different execution modes of the threads above increases the chance of running four threads concurrently, which is an ideal state and increases the instruction output rate to the greatest extent.

By transferring the best load balance, the interaction between the minimum MVP and the host CPU and the data movement between the MVP and the host memory, the MVP thread has the best cost-performance configuration.

For the computing of resource by fully using hardware in a multi-task or/and multi-data room, load balance is an effective method; the MVP has two ways to manage load balance, wherein one way is to configure four activated threads (in the task thread mode or the MVP thread mode, eight threads are activated) through any available mode (typically, through a common IPA) by using software; the other way is to dynamically update, check and adjust the running threads during running time by using hardware. In the configuration process of software, just as we know that most application characteristic needs to set static task division for special application in initial time; however, the second way requires the hardware to have a capability of dynamic adjustment in different running time. The two ways above enable the MVP to reach maximum instruction output bandwidth in the condition of maximum hardware utilization; however, latency hiding depends on the double-output capability for keeping four-output rate.

The MVP configures four threads by configuring the thread control register using software, wherein each thread comprises a register configuration set and the set includes Starting_PC register, Starting_GM_base register, Starting_LM_base register and Thread_cfg register, in which, the Starting_PC register is used for indicating the start physical location of a task program; the Starting_GM_base register is used for indicating the base point location of the thread local storage unit for starting a thread; the Starting_LM_base register is used for indicating the base point location (only for MVP thread) of the thread global memory for starting a thread; and the Thread_cfg register is used for configuring threads and further comprises: Running Mode bit, which indicates common when being 0 and indicates preferred when being 1; Thread_Pri bit, which sets the running priority (0level-7 level) of thread; Thread Types bit, which indicates thread unavailable when being 0, indicates a data thread when being 1, indicates a task thread when being 2 and indicates an MVP thread when being 3.

If a thread is in the data thread or task thread mode, when the thread is activated, the thread enters to the running status in a next period; if the thread is in the MVP mode, the thread buffering and the validity of input data are checked regularly in each period; once prepared, the activated threads enter to the running status; a thread which enters to the running status uploads the value in the Starting_PC register to one of four program counters (PC) of the running channel program, then the thread starts to run. For thread management and configuration parameters, refer to FIG. 7. In FIG. 7, a running thread 601 reads or accepts the values of a thread configuration register 602, a thread status register 603 and an I/O buffer status register 604, and converts the values into three control signals to output, wherein the control signals include: Launch-valid, Launch-tid and Launch infor.

When executing to the instruction EXIT, the thread is completed.

The three threads above can only be disabled by software. The MVP thread can be set to Wait state when the hardware ends the current data set, waiting a next data set of the thread to be prepared or sent to the corresponding local storage area.

The MVP has no internal hardware connection between the data thread and the task thread, except a shared memory and a barrier feature with API definition. Each of the threads is processed as a completely independent hardware. Even so, the MVP provides inter-thread interrupt characteristics; then each thread can be interrupted by any one of other kernels. Inter-thread interrupt is software interrupt which is written into a software interrupt register by the running thread to particularly interrupt a specified kernel, including the kernel of the inter-thread interrupt itself. After such an inter-thread interrupt, the terminal program of the interrupted kernel is called.

Just like a conventional interrupt processing program, if the interrupt in the MVP is enabled and configured, each of the interrupted threads goes to a preset interrupt processing program. If software is enabled, each MVP responds to external interrupt. An interrupt controller processes all interrupts.

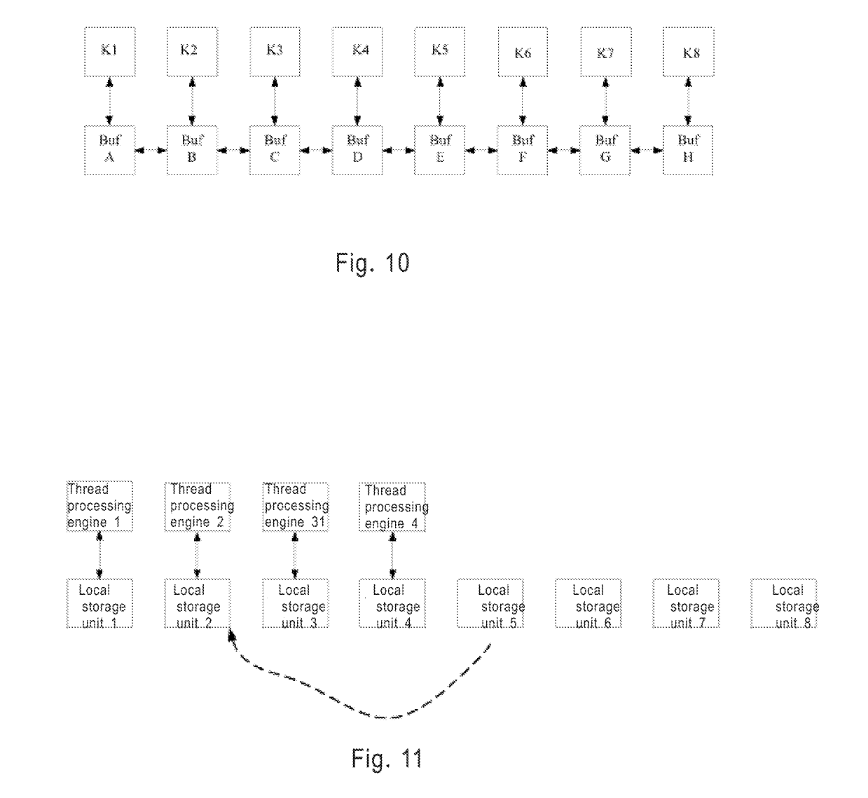

All MVP threads are viewed as a specific integrated circuit channel of hardware; therefore, each interrupt register is used for adjusting the sleep and awaking of a single thread. The thread buffer is used as an inter-thread data channel. The rules of the MVP thread are divided using software, similar to the characteristics of multi-processor in the task parallel computing mode, that is, any data stream passing through all threads is unidirectional so as to avoid the interlocking between any threads, which means that the function with data forward or backward switching is viewed as a kernel which is kept in a single task; therefore, after software initialization configuration is performed, the inter-thread communication fixedly passes through a virtual DMA channel and is automatically processed by hardware during the running time; thus, the communication becomes transparent for software and does not active the interrupt processing program unnecessarily. Referring to FIG. 10, FIG. 10 shows eight kernels (applications, K1 to K8) and the corresponding buffer areas (Buf A to Buf H), wherein the buffer areas are connected via virtual DMA channels for fast data copy.

The MVP has a 64 KB SRAM in the kernel as a thread buffer, wherein the SRAM is configured as 16 areas, each area with 4 KB; the areas are mapped to a fixed space of the local storage unit by each thread memory. For the data thread, the 64 KB thread buffer is the entire local storage unit, like a typical SRAM. Since there are at most four work items belonging to the same work group, for example, four threads, the thread processing can be linearly addressed (referring to FIG. 3).

For the task thread, the 64 KB thread buffer can be configured as at most eight different local storage unit sets, each set corresponding to a thread. (Referring to FIG. 4) the numerical value of each local storage unit can be adjusted by software configuration.

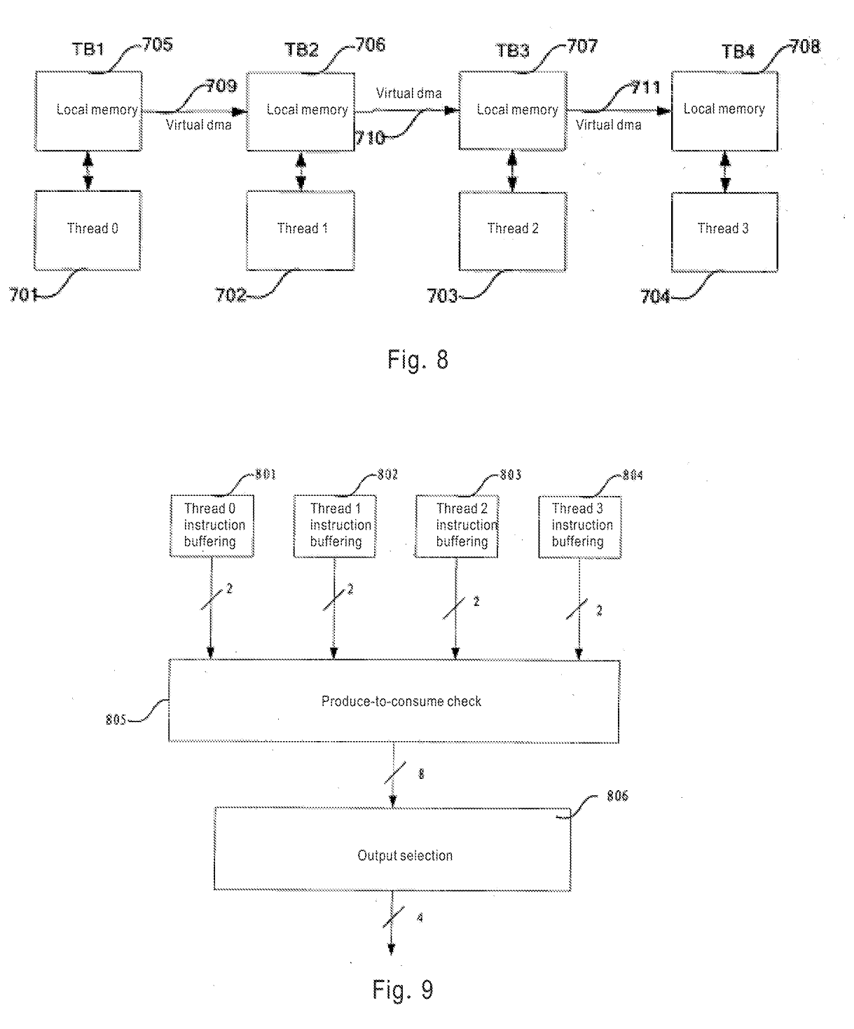

For the MVP thread mode, the configuration of the 64 KB thread buffer has only one mode as shown in FIG. 8. Just like the task thread mode, each MVP thread has a directed thread buffer as the local storage unit of the kernel; in the condition that four threads are configured as shown in FIG. 8, each thread has a 64 KB/4=16 KB local storage unit. In addition, the kernel can be viewed as a virtual DMA engine, which can copy the content in the local storage unit of a thread to the local storage unit of a next thread entirely and instantaneously, wherein the instantaneous copy of stream data is realized by dynamically changing the virtual physical mapping in the activated thread by the virtual DMA engine. Each thread has its own mapping, and when the execution of the thread is completed, the thread upgrades its own mapping and restarts execution in accordance with the following rules: if the local storage unit is enabled and is valid (input data arrives), the thread is ready to start; after the thread is completed, the mapping is switched to a next local storage and the local storage unit of the current mapping is marked to be valid (output data prepares for a next thread); return to the first step.

In FIG. 8, thread 0 701, thread 1 702, thread 2 703 and thread 3 704 are respectively connected with the storages areas (705, 706, 707, 708) which are mapped as the local storage units; the storage areas above are connected via virtual DMA connections (709, 710, 711). It is worth mentioning that in FIG. 8 the virtual DMA connections (709, 710, 711) do not exist in hardware; in the embodiment, data transfer in the storage areas is realized by changing the configuration of thread, thus from outside it seems that connections exist, actually, hardware connection does not exist, so are the connections from Buf A to Buf H in FIG. 10.

Note that, when a thread is ready to start, if there is other thread which is ready, the thread might not be started, particularly in the condition of more than four activated threads.

The operation of the thread buffer above is mainly to provide in the MVP thread mode a channel data stream mode which moves the content in the local storage unit of an earlier thread to the local storage unit of a latter thread without performing any mode of data copy, so as to save time and electricity.

For the input and output stream data of the thread buffer, the MVP has a separate 32-bit data input and a separate 32-bit data output which are connected to the system bus via external interface buses; therefore, the MVP kernel can transmit data to/from the thread buffer through load/store instruction or virtual DMA engine.

If a specific thread buffer area is activated, it means that the thread buffer area together with the thread is executed and can be used by the thread program. When an external access attempts to write, the access is delayed by out-of-synchronization buffering.

In each period, for a single thread, there are four instructions being fetched. In the common mode, the instruction fetch timeslot is transferred in all running treads in a circular mode, for example, if there are four running threads, each thread fetches instructions every four periods; if there are four running threads and two of them are in a preferred mode which allows two instructions to be output in each period, the interval above is reduced to 2. The value selection of the thread depends on the circular instruction fetch token, the running mode and the status of the instruction fetch buffer.

The MVP is designed to support four threads to run concurrently, wherein at least two threads run concurrently; therefore, instruction is not fetched in each period, thus enough time is reserved for establishing a next PC directed address for any type of unlimited stream programs. Since the design point is four running threads, the MVP has four periods before a next instruction fetch of the same thread, thus three periods are provided for tributary resolution delay. Although addressing seldom exceeds three periods, the MVP has a simple tributary prediction policy for reducing the tributary resolution delay of three periods, wherein the MVP adopts a static always-not-taken policy. In the condition of four running threads, the simple tributary prediction policy does not produce an effect of causing possible errors, because the PC of the thread performs tributary resolution while fetching instructions; therefore, the characteristic is determined by design performance to start or stop, no further design is needed to adapt to different number of running threads.

As shown in FIG. 9, the point that the MVP always outputs four instructions (referring to the output selection 806 in FIG. 8) in each period is an important point. In order to find four prepared instructions from the thread instruction buffer, the MVP checks eight instructions, that is, two instructions of each running thread (801, 802, 803, 804), wherein the instructions are transmitted to the output selection 806 through produce-to-consume 805. Generally, if mismatch does not exist, each running thread outputs an instruction; if mismatch exists, for example, implementation result is waited for a long time or there are not enough running threads, the two checked instructions of each thread detect any ILPs in the same thread, so as to hide paused thread latency and achieve maximum dynamic balance. Besides, in the preferred mode, in order to achieve maximum load balance, two prepared instructions of the thread with higher priority are selected prior to that of the thread with lower priority, which is good for bettering utilizing any ILPs of the thread with higher priority, shortens the operation time of more time-sensitive tasks and enhances the capability which can be applied to any thread mode.

Since the MVP has four LAUs, four MACs and at most four outputs in each period, resource produce-to-consume is set generally, except referring to a fixed function unit; however, similar to a general processor, there exists data produce-to-consume which needs to be cleared before instruction is output. Between any two instructions output in different periods, there might exist long latency produce-to-consume, for example, a producer instruction of long latency specified function unit occupying n periods, or a load instruction at least occupying two periods. In this condition, any consumer instruction is mismatched to know that the produce-to-consume is cleared. In order to keep load balance, more than one instruction needs to be sent out in a period; or in order to hide latency, produce-to-consume check should be performed when the second output instruction is sent out, so as to confirm that no correlation is produced to the first instruction.

Latency hiding is the important characteristic of the MVP. In the MVP instruction implementation channel, there are two conditions of long latency; one is the special function unit and the other is the access to external memory or I/O. In any condition, the requested thread is set to Pause state, and no instruction is output until the long latency operation is completed. During this time, there is one running thread less and other running threads would fill the idle timeslot to utilize extra hardware; now provided that each special function unit is combined with a thread only, if anytime there is more than one thread running on the specified special function unit, resource shortage of the special function unit is not necessarily to be worried; at this moment, one ALU can not implement the load instruction processing alone; if the load instruction loses a buffer, the load instruction can not occupy the channel of the specified ALU, because the ALU is a general execution unit and can be used by other threads freely; thus, for long-latency load access, we adopt a method of instruction cancel to release the channel of ALU. The long-latency load instruction has no need to wait in the channel of ALU like a common processor; contrarily, the long-latency load instruction is resent when the thread runs again from the Pause state.

As mentioned above, the MVP does not perform any tributary prediction, thus no deduction is performed; therefore, the only condition causing the instruction cancel is from load latency pause; for any known buffer loss, at the instruction submission stage of MVP, the Write Back (WB) stage that one instruction can be complete certainly is a data memory access (MEM) stage. If buffer loss has occurred, the occupied load instruction is canceled, thus all instructions upgrade from the MEM stage to the IS stage, that is, the MEM plus execution or address calculation (EX), and the follow-up instructions are canceled too; the threads in the thread instruction buffering would enter to Pause state until they are awaken by a awaking signal, which means that the threads in the thread instruction buffer have to wait until they find the MEM stage; meanwhile, the operation of instruction pointer needs to consider the possibility of any type of instruction cancel.

FIG. 11 shows an example of the embodiment; four thread processing engines are configured to execute four tasks respectively; the local storage units 1 to 4 are configured to the thread processing engines 1 to 4 respectively to run and to store the data of each task respectively; in addition, the local storage unit 5 stores the data of the task 2; when the thread processing engine 2 finishes processing the data of the local storage unit 2 and releases the local storage unit 2, the local storage unit 5 is configured to the thread processing engine 2 through the management unit (the thread management and control unit 1 as shown in FIG. 2), wherein the thread processing engine 2 directly processes the data of the local storage unit 5, without copying the data in the local storage unit 5 to the local storage unit 2; thus, time and electricity used by copying are saved; high cost performance is achieved. Of course, the operations of other thread processing engines and other local storage units are mostly the same.

The embodiment above only expresses several implementations of the present invention; the description is specific and detailed, however, it can not be interpreted as a limit to the scope of the present invention. It should be noted that for the ordinary technicians of the field various modifications and improvements can be made without departing from the idea of the present invention; these modifications and improvements all belong to the protection scope of the present invention; therefore, the protection scope of the invention is based on the claims attached hereto.

What is claimed is:

1. A stream data processing method, comprising the steps as follows:
A) obtaining from data a program pointer indicating a task to which the pointer belongs, and configuring a thread processing engine according to the program pointer;
B) processing simultaneously the data of the different durations of the task or the data of different tasks by a plurality of thread engines;
C) deciding whether there is data still not processed, and if yes, returning to the Step A); and if not, exiting this data processing.

2. The stream data processing method according to claim 1, wherein the Step A) further comprises a step of:
A1) respectively allocating the data of the different durations of the same task or the data of a plurality of tasks to different idle local storage units which are connected with the thread processing engines via virtual direct memory access (DMA) channels.

3. The stream data processing method according to claim 1, wherein the Step A) further comprises the steps of:
A2) allocating the same task to the plurality of thread processing engines;
A3) initializing each thread processing engine, and connecting the thread processing engine with a local storage unit through the virtual DMA channel by setting a storage pointer;
A4) processing simultaneously, by the plurality of thread processing engines, the data in the local storage units connected with the thread processing engines.

4. The stream data processing method according to claim 1, wherein the Step A) further comprises the steps of:
A2′) allocating a plurality of tasks to the plurality of thread processing engines respectively;
A3′) initializing each thread processing engine, and connecting the thread processing engine with a local storage unit through the virtual DMA channel by setting a storage pointer;
A4′) processing simultaneously, by the plurality of thread processing engines, the data in the local storage units connected with the thread processing engines.

5. The stream data processing method according to claim 3 or 4, wherein the Step C) further comprises the steps of:
C1) releasing the local storage unit connected with the multi-thread processing engine through the virtual DMA channel;
C2) deciding whether there is data not processed in the local storage units not connected with the plurality of thread processing engines, if yes, returning to Step A), if not, executing Step C3);
C3) releasing all resources and ending this data processing.

6. The stream data processing method according to claim 5, wherein the number of the thread processing engines is four, and the number of the local storage units is four or eight.

7. The stream data processing method according to claim 3 or 4, further comprising a step of: when receiving an interrupt request sent by the task or hardware, interrupting the processing of the thread processing engine allocated to the task and executing an interrupt processing program.

8. The stream data processing method according to claim 3 or 4, further comprising a step of: when any of the running thread processing engines needs to wait a long time, releasing the thread processing engine and configuring it to another same or different running task.

9. A stream data processor, comprising:
a plurality of parallel thread processing engines for processing tasks or threads allocated to the thread processing engines;
a management unit for obtaining, judging and controlling the statuses of the plurality of thread processing engines, and allocating the threads or tasks in a waiting queue to the plurality of thread processing engines;
a local storage area for storing the data processed by the thread processing engine and cooperating the thread processing engine to finish the data processing.

10. The stream data processor according to claim 9, further comprising an internal storage system for data and thread buffering and instruction buffering, and a register for storing various statuses of the parallel processor.

11. The stream data processor according to claim 9, wherein the thread processing engine comprises an arithmetic logic unit (ALU) and a multiply-add unit (MAC) corresponding to the ALU.

12. The stream data processor according to claim 9, wherein the local storage area comprises a plurality of local storage units; and the local storage unit is configured to correspond to the thread processing engine when the thread processing engine works.

13. The stream data processor according to claim 12, wherein the thread processing engines are four and the local storage units are eight; when the thread processing engines work, any four of the local storage units are configured to correspond to the thread processing engines one to one respectively.

14. The stream processor according to any one of claims 9 to 12, wherein the management unit comprises:
a software configuration module for setting a task for the thread processing engine according to an initial program pointer;
a task initialization module for setting the local storage area pointer and global storage area pointer of the task;
a thread configuration module for setting the priority and the running mode of a task;
an interrupt processing module for processing the external or internal interrupt received by the stream processor;
a pause control module for controlling the pause or the restart when the thread processing engine processes a task.

15. The stream data processor according to claim 14, wherein the management unit further comprises a thread control register; the thread control register further comprises an initial program pointer register for indicating the start physical address of a task program, a local storage area start base point register for indicating the start address of the local storage area, a global storage area start base point register for indicating the start address of the thread global storage area and a thread configuration register for setting the priority and the running mode of the thread.

16. The stream data processor according to claim 15, wherein the management unit changes the task run by the thread processing engine by changing the configuration of the thread processing engine; the configuration comprises changing the value of the initial program pointer register or changing the local storage unit pointer pointing to the local storage unit.

17. The stream data processor according to claim 16, wherein the interrupt processing module comprises an interrupt processing unit; the thread interrupt unit controls the interrupt of threads in the kernel or other kernels when the control bit of the interrupt register is set.
